(19) United States
(12) Patent Application Publication
(10) Pub. No.: US 2007/0162553 A1
(43) Pub. Date: Jul. 12, 2007

(54) Interactive moderated voice chat system

(76) Inventors: Shane Richard Dewing, Sherman Oaks, CA (US); M. Dean Newton, Palm Springs, CA (US); Anthony Pierre Stonefield, Sherman Oaks, CA (US); Gary Passon, Encino, CA (US); Lex Meirop, Newbury Park, CA (US)

Correspondence Address: GORDON & JACOBSON, P.C., 60 LONG RIDGE ROAD, SUITE 407, STAMFORD, CT, 06902, US

(21) Appl. No.: 11/329,022

(22) Filed: Jan. 10, 2006

(51) Int. Cl. G06F 15/16

(52) U.S. Cl. 709/207

(57) ABSTRACT

A moderated voice chat service is provided that is participated by a group of anonymous users. A Conference Bridge interfaces to the communication network. The Conference Bridge is capable of placing (and possibly receiving) voice calls to (from) users of the communication network in order to connect users to the service. The Conference Bridge also facilitates voice chatting between multiple users by bridging together multiple voice connections as a multiparty conference. Such a multiparty conference facilitates the realization of a public voice chat room whereby multiple anonymous users communicate with one another via spoken words. The Conference Bridge also facilitates moderation of the public voice chat room by bridging a designated moderator to the multiparty conference as needed. The IVR functionality of the Conference Bridge preferably presents the user with a voice menu that identifies a plurality of moderated voice chat room sessions and bridges the user to one of these moderated voice chat room sessions as selected by the user. Users preferably pay for access to the moderated voice chat room sessions by a premium rate messaging scheme, such as premium-SMS or premium-MMS billing. In these premium rate message payment schemes, mobile users are charged a premium fee that is billed to his/her mobile carrier account when a premium rate message type is received (or sent) from the user's mobile unit.

### BACKGROUND OF THE INVENTION

1. Field of the Invention

This invention relates broadly to voice communication systems. More particularly, this invention relates to voice chat services over telephone networks.

2. State of the Art

Public text chat room services have become popular. In such public text chat room services, anonymous users communicate with one another via text-based messages such as SMS messages or IM messages. There are thousands of such public text chat rooms, each of which is typically dedicated to a specific topic. Although such public text chat room services are very popular, they are cumbersome to use because users input their text-based messages via a keyboard, keypad or other pen-based input mechanism.

Public voice chat room services have been proposed. In such public voice chat room services, anonymous users communicate with one another over a voice conference bridge. For example, U.S. Pat. No. 6,931,114 to Martin describes a public voice chat room service that connects multiple mobile phone callers to a conference bridge circuit. The mobile phone callers access the chat service by dialing a telephone number that is associated with the service. A verification process is performed to determine that the caller is a subscriber of the service. After successful verification, the subscriber is presented with a menu of options/sub-options. The subscriber selects one of the menu options (via key presses) and is connected to a chat room corresponding thereto. The conversation between callers of the chat room may be moderated by a participant that is a designated representative of the chat service provider. The designated representative may remove one or more callers from the chat room if the caller does not comply with the rules of the service. Subscribers may be billed a flat monthly fee or pay based upon the amount of time spent in the chat rooms.

Although the public voice chat room service of Martin provides enhanced services, it suffers from several shortcomings, which include: (i) users are required to dial the telephone number of the service in order to connect to the moderated voice chat service and thus incur charges associated with the outbound call; (ii) dialing the telephone number of the service can also be cumbersome to do in some circumstances; and iii) subscriber-based billing is complex and inefficient requiring that the user provide personal information to the service provider and requiring the service provider to maintain a technical infrastructure that bills individual subscribers and collects payments therefrom.

### SUMMARY OF THE INVENTION

It is therefore an object of the invention to provide an interactive moderated voice chat service that does not require users to dial the telephone number of the service in order to connect to the voice chat service.

It is another object of the invention to provide such an interactive moderated voice chat service that avoids subscriber-based billing.

In accord with these objects, which will be discussed in detail below, an interactive moderated voice chat service is provided that is participated in by a group of anonymous users. An interactive voice response (IVR) Multiple Party Conference Bridge interfaces to the communication network. The Conference Bridge is capable of placing (and possibly receiving) voice calls to (from) users of the communication network in order to connect users to the service. The Conference Bridge also facilitates voice chatting between multiple users by. bridging together multiple voice connections as a multiparty conference. Such a multiparty conference facilitates the realization of a public voice chat room whereby multiple anonymous users communicate with one another via spoken words. The Conference Bridge also facilitates moderation of the public voice chat room by bridging a designated moderator to the multiparty conference as needed. In one embodiment, the IVR functionality of the Conference Bridge presents the connected user with a voice menu that identifies a plurality of moderated voice chat room sessions and bridges the user to one of these moderated voice chat room sessions as selected by the user. Users pay for access to the moderated voice chat room sessions by a premium rate messaging scheme, such as premium-SMS or premium-MMS billing. In these premium rate message payment schemes, mobile users are charged a premium fee that is billed to his/her mobile carrier account when a premium rate message type is received (or sent) from the user's mobile unit.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic diagram of an embodiment of an interactive moderated voice chat system in accordance with the present invention.

FIGS. 2A-2D is a flow chart, collectively, illustrating operations for user access to the interactive moderated voice chat system of FIG. 1 and for premium-SMS billing in conjunction therewith.

FIG. 3 is a flow chart illustrating operations carried out by the conference bridge of FIG. 1 in management of a voice chat session.

FIG. 4 is a schematic diagram of an alternate embodiment of an interactive moderated voice chat system in accordance with the present invention.

### DETAILED DESCRIPTION OF THE PREFERRED EMBODIMENTS

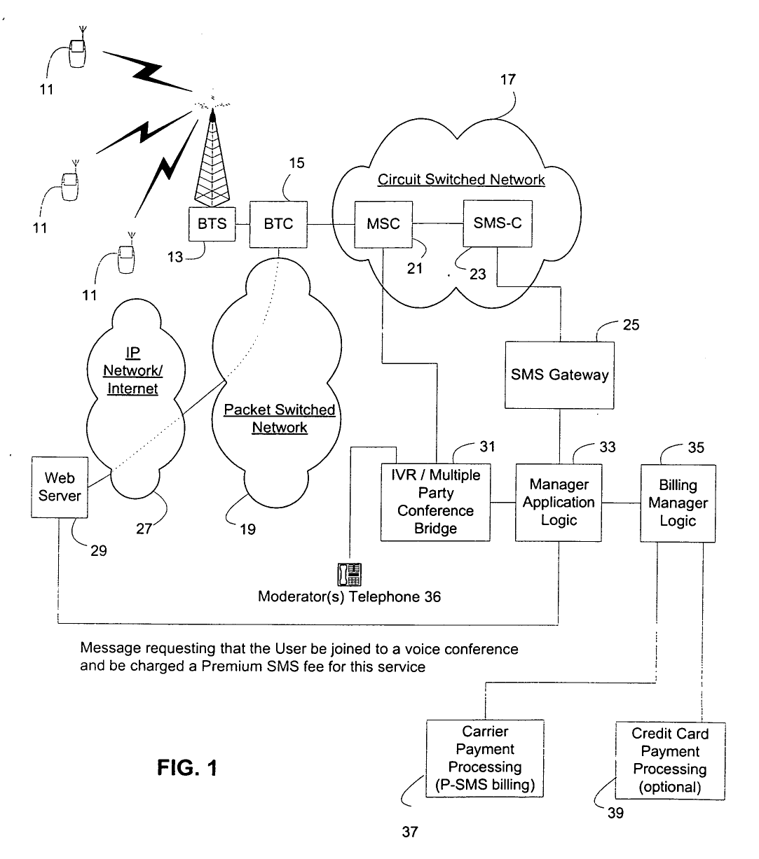

Turning now to FIG. 1, there is shown a schematic diagram of an exemplary voice chat system over a cellular wireless communication network. Mobile units 11 communicate over wireless directional communication links to base stations 13 (one shown). The base stations 13 are operably coupled to base station controllers 15 (one shown), which are responsible for radio resource allocation to the mobile units 11, frequency administration and handover between base stations 13. The base station controller function may be physically located within a base station 13 itself. The base station controllers 15 interface to a circuit switched network 17 and a packet switched network 19. Circuit switched traffic (e.g., voice calls, SMS messages) is routed over the circuit switched network 17. Packet switched traffic (e.g., GPRS data) is routed over the packet switched network 19. The circuit switched network 17 includes a mobile switching center (MSC) 21 and a SMS center (SMS-C) 23. The MSC 21 provides the signaling functions that are necessary to establish voice calls to and from the mobile units 11. Generally, the MSC 21 connects the circuit switched network 17 to the public switched telephone network (not shown) and manages and routes voice traffic into and out of the circuit switch network 17. The SMS-C 23 functions as a centralized store-and-forward device that accepts SMS messages and buffers the received SMS messages until a suitable delivery time (i.e., the cell phone is powered on and the location known). The SMS-C 23 also provides an interface in accordance with a communication protocol (e.g., UCP, SMPP, Sema OIS, CIMD2) that allows for routing of SMS messages to and from other cell networks and to and from other external SMS processing devices (e.g., the SMS gateway 25). Preferably, the external SMS processing devices are connected to the SMS-C23 over a wide area network such as the Internet. The packet switched network 19 interfaces to an IP network 27 (e.g., the Internet) to which is connected a Web Server 29.

The Web Server 29 supports the HTTP protocol over TCP/IP as well as the Wireless Application Protocol (WAP). HTTP is a specification that allows users to access information by a web browser (e.g., Internet Explorer, Firefox, and Opera). WAP is a specification that allows users to access information instantly via mobile wireless devices such as mobile phones, pagers, two-way radios, smart phones and communicators. WAP supports most wireless networks (including CDPD, CDMA, GSM, PDC, PHS, TDMA, FLEX, ReFLEX, IDEN, TETRA, DECT, DataTAC, and Mobitex) and is supported by operating systems specifically engineered for mobile wireless devices (including PalmOS, EPOC, Windows CE, FLEXOS, OS/9, and JavaOS). The WAP-enabled wireless devices employ a micro-browser (i.e., a browser with small file sizes that can accommodate the low memory constraints of mobile wireless devices and the low-bandwidth constraints of a wireless network infrastructure) to access the Web Server 29 over the packet switched network 29 and the IP Network 19. The WAP-enabled Web Server 29 supports HTML, XML, WML as well as xHTML. WML and XHTML are mark-up languages and specifications that are specifically devised for small screens and one-hand navigation without a keyboard. WML and xHTML are scalable from two-line text displays up through graphic screens found on items such as smart phones and communicators. The WAP-enabled Web Server 29 also preferably supports WMLScript, which is similar to JavaScript but makes minimal demands on memory and CPU power because it does not contain many of the unnecessary functions found in other scripting languages.

The Web Server 29 servers a page that displays an invitation to join a voice chat room that is participated in by a group of users as described below in more detail. An interactive voice response (IVR) Multiple Party Conference Bridge 31 interfaces to the MSC 21 preferably over the public switched telephone network or a voice-over-IP telephone network (not shown). The Conference Bridge 31 is capable of placing (and possibly receiving) voice calls to (from) mobile users of the cellular wireless network via the MSC 21. The Conference Bridge 31 also facilitates voice chatting between multiple mobile users by bridging together multiple voice connections as a multiparty conference as is well known in the art. Such a multiparty conference facilitates the realization of a public voice chat room whereby multiple anonymous users communicate with one another via spoken words as described below. The Conference Bridge 31 also facilitates moderation of the public voice chat room by bridging a designated moderator to the multiparty conference as needed.

Mobile users pay for access to the public voice chat room by a premium-SMS payment scheme. In this payment scheme, the mobile user is charged a premium fee (e.g., $5.99) that is billed to his/her mobile carrier account when a premium-SMS message type is received or sent from the user's mobile unit 11. Mobile-Terminated (MT) Billing refers to the scheme where the Premium-SMS message is billed when it is received on the user's mobile unit 11. Mobile-Originated (MO) billing refers to the scheme where the premium-SMS message is billed when it is sent from the user's mobile unit 11. The embodiment described below employs MT Billing. However, it can readily be adapted to use MO Billing as needed.

In order to support the premium-SMS payment scheme, the system includes an SMS gateway 25 that interfaces to the SMS-C 23, Billing Manager Logic 35 that interfaces to the carrier billing processing system 37, and Manager Application Logic 33 that interfaces to the SMS gateway 25, the Billing Manager Logic 35 and the Conference Bridge 31 as shown. The Billing Manager Logic 35 may also interface to a credit card payment processor 39 as shown in order to support credit card payments and possibly debit card payments for user access to the voice chat service described herein.

The SMS gateway 25 generates outgoing MT SMS messages from a predetermined short code (e.g., 2999) to one or more of the mobile units 11 and forwards the MT SMS messages to the SMS-C for forwarding to the destination mobile unit(s). The SMS gateway 25 also receives incoming MO SMS messages from the mobile units 11 to the predetermined short code (e.g., 2999). The SMS gateway 25 interfaces to the SMS-C 23 utilizing a communication protocol such as UCP, SMPP, Sema OIS, or CIMD2 that allows for the routing of SMS messages therebetween. Preferably, the SMS Gateway 25 is connected to the SMS-C 23 over a wide area network such as the Internet.

As described below in more detail, the Manager Application Logic 33 coordinates with the SMS gateway 25 to request and acknowledge payment for user access to the voice chat room service by premium-SMS payment. The Manager Application Logic 33 also coordinates with the Billing Manager Logic 35 to confirm that the premium-SMS payment was billed by the carrier. Alternatively, the Manager Application Logic 33 may coordinate with the Billing Manager Logic 35 to charge the premium access fee (and/or other service related fees) to a credit card account or possibly a debit card account provided by the mobile user.

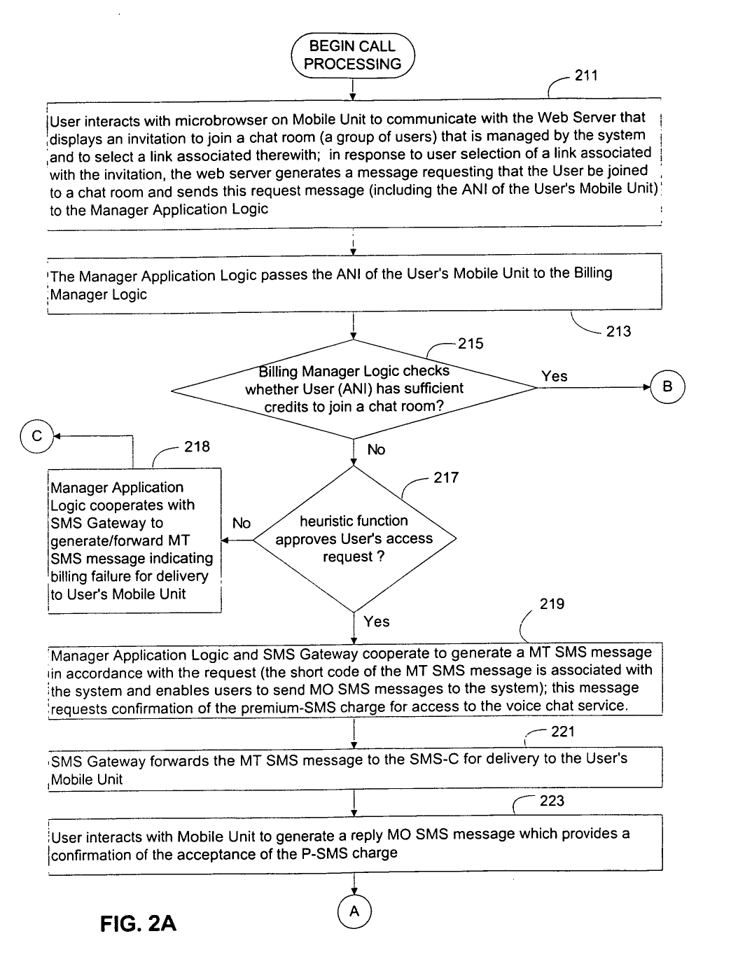

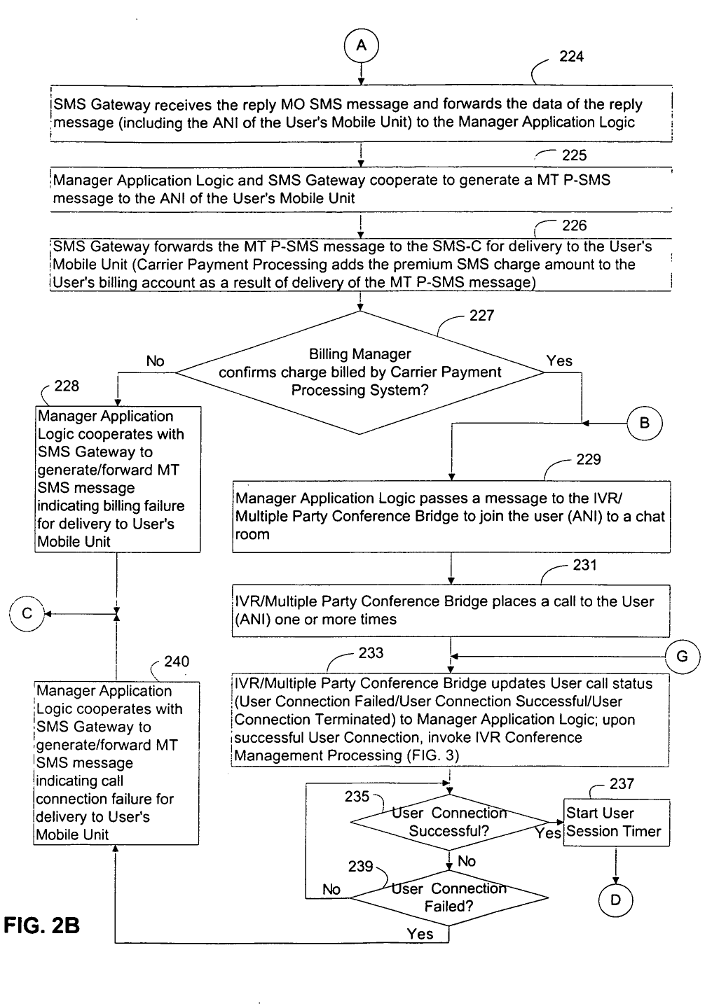

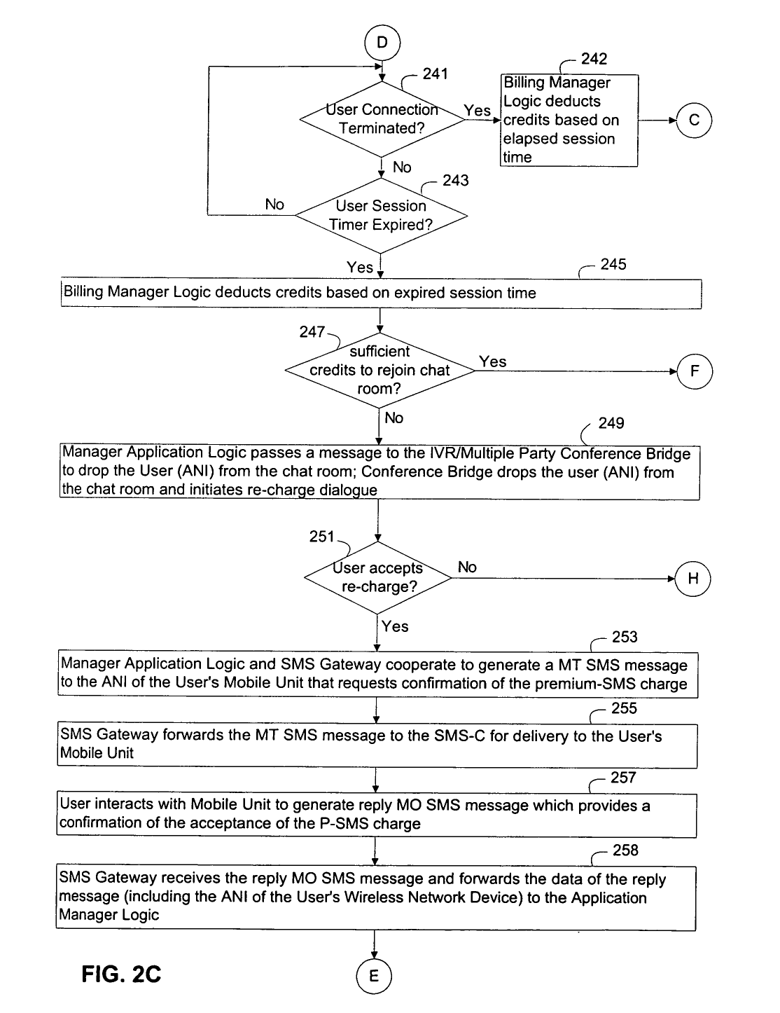

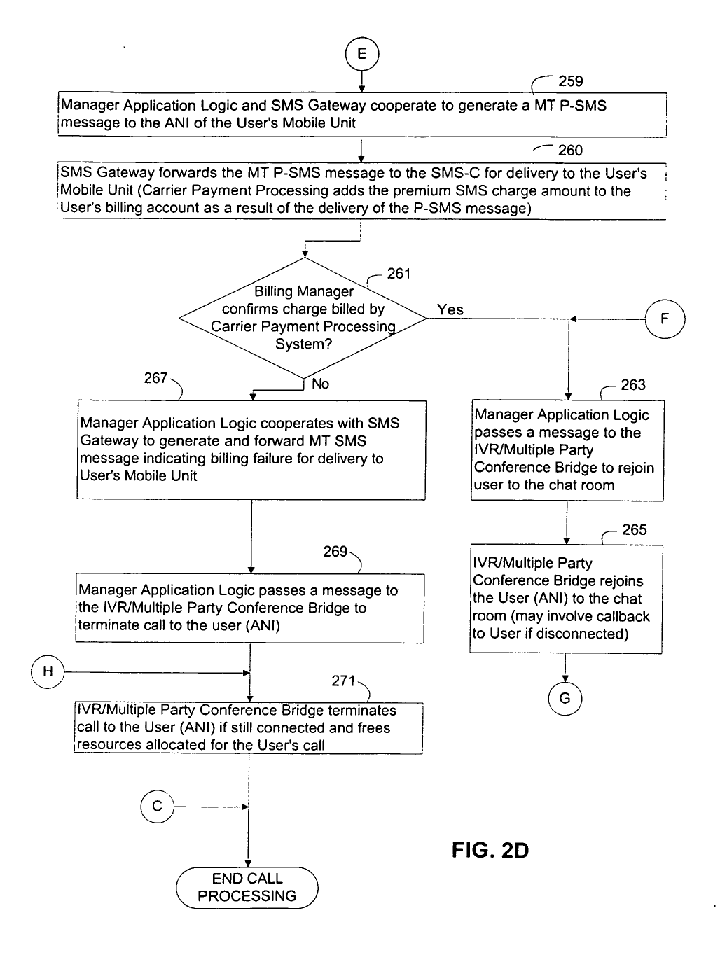

Mobile users can access the voice chat room service by several methods. One method that is suitable for WAP-enabled mobile units 11 is carried out by user interaction with a micro-browser executing on a WAP-enabled mobile unit 11. This methodology is described in FIGS. 2A through 2D wherein the user browses to a WML page served by web server 29 that displays an invitation to join a voice chat room that is participated by a group of anonymous users (block 21 1). The invitation preferably notes that the mobile user will be charged a one-time premium-SMS fee (e.g., $5.99) for a number (e.g., 10) of minutes of access to the voice chat service. The invitation can also provide a notification that the mobile user should expect a confirmation SMS message and that the mobile user will be connected to the voice chat service by a call from a specific number or short code (e.g., 29999). A simplified form of an exemplary WML page as rendered on the display of the user's mobile unit 11 is shown below:

Join a conference with a group of anonymous users
$5.99 for 10 minutes of enjoyment

| | |
|---|---|
| Chat rooms | Hot Movies, Press 1# |
| | Hot Music, Press 2# |
| | Personal Confessions, Press 3# |
| | Relationships, Press 4# |
| | Astrology, Press 5# |

The invitation also provides a “hot link” button that when selected by the user causes the WAP-enabled web server 29 to generate a message requesting that the particular mobile user be joined to the voice chat service and to communicate this message to the Manager Application Logic 33. This message identifies the particular mobile user by the ANI (Automatic Number Identification) of the particular mobile user.

In block 213, the Manager Application Logic 33 passes the ANI of the particular mobile user to the Billing Manager Logic 35.

The Billing Manager Logic 35 maintains a database that tracks credits for users of the system. The users of the system are identified by their respective ANIs. The credits can be minutes that correspond to moneys that have been billed to the user but have yet to be used in accessing the voice chat system, or the actual money values themselves. Preferably, the credits have a limited lifetime (e.g., 90 days). If not used by the user, the credits are removed from the system upon expiration of their respective lifetime.

The Billing Manager Logic 35 also maintains a heuristic function that tracks and analyzes user-specific access requests against a set of maxims, which result in a deterministic, reproducible and trackable result. The maxims are designed specifically to mitigate the risk of non-payment or charge-backs on traditionally high risk non-face-to-face transaction processing. The set of n maxims are arranged in a linear fashion. The purpose of the heuristic function is to approve an access request for a specific user, for a particular billing amount against a particular bill type for a particular service (e.g., a $25 charge against user 1234, using billing type Credit Card (CC# 1234 5678 1234 5678), for service descriptor 5678). There are a standard set of common maxims and a set of custom maxims for variant bill types (Premium-SMS bill type, Credit Card bill type, Debit Card bill type, what is LEC billing, etc.) and for variant service descriptors (products).

The common maxims are generally designed around usage. For example, if this is the first usage of a particular service with the particular bill type, the maxim may ask for additional information from the user before any further processing. If the bill type is Credit Card, that additional information could be expiration date, zip code or CVV information. Once this information is received and verified, then the heuristic function can proceed to the next maxim. The next time the heuristic function is requested against the same credit card, the maxim would discover the additional information from the prior attempt and proceed directly to the next maxim. Other common maxims define blocked users (automatic denial) with granularity on the block attaching to the bill type and the service descriptor.

The custom maxims pertaining to variant bill types are designed around particular velocities. Velocity refers to the gross number of access requests that are processed against the bill type for the user in the prior period, determined by number of days, weeks, months and years. The custom maxims pertaining to variant service descriptors are designed around risk groups. A risk group defines the acceptable velocities for each bill type for a particular service descriptor (e.g., a user can charge a maximum of $50 per calendar month for credit card billing for service descriptor 5678). Preferably, the velocities are not summed by service descriptor, meaning that the same user may be able to charge against the same credit card for service descriptor 1234 but not against service descriptor 5678 because they have hit the velocity limit for credit card billing on service descriptor 5678.

In response to the message communicated from the Manager Application Logic 33 in block 213, the Billing Manager Logic 35 checks this database to determine whether the User (ANI) has sufficient credits to join a chat room (block 215). In an illustrative embodiment, the User is billed $5.99 US dollars for 10 minutes of access to the voice chat service and must have at least one (1) minute of credit in the database to join a chat room. If this test is successful, the operations continue to block 229 as described below; otherwise the operations continue to block 217.

In block 217, the Billing Manager Logic 35 calls the heuristic function as described above to analyze the user's access request against the set of maxims stored therein. As described above, the maxims are designed specifically to mitigate the risk of non-payment or charge-backs on traditionally high risk non-face-to-face transaction processing. The result of the heuristic function either approves or disapproves the user's request for a particular bill type (Premium-SMS billing) for a particular service and for a particular amount (e.g., $5.99 premium access fee). If the heuristic function disapproves the user's access request, the operations continue to block 218 wherein the Manager Application Logic 33 cooperates with the SMS Gateway 25 to generate an MT SMS message addressed from the system's short code (e.g., 29999) and addressed to the ANI of the user. This SMS message provides an indication of the billing failure. The SMS gateway 25 forwards this SMS message to the SMS-C 23 for delivery to the user's mobile unit 11 and the processing ends. If the heuristic function approves the user's access request, the operations continue to block 219.

In block 219; the Manager Application logic 33 cooperates with the SMS Gateway 25 to generate a MT SMS message addressed from the system's short code (e.g., 29999) and addressed to the ANI of the user. The short code embedded within the “from” address of this MT SMS message enables the user to send a reply MO SMS message back to the system (block 223). This SMS message requests user confirmation that the User accepts the premium SMS charge (e.g., $5.99). A simplified form of an exemplary MT premium-SMS message generated in block 219 as rendered on the display of the user's mobile unit 11 is shown below:
From: 29999
To: (ANI)
By replying “Yes” or “Y” to this message, you confirm that you want to buy 10 minutes of call time in a voice chat conference for a one-time charge of $5.99 on your mobile phone account. If you respond “Yes”, you will receive a phone call within 5-30 seconds.

In block 221, the SMS Gateway 25 forwards the MT SMS-message generated in block 219 to the SMS-C 23 for delivery to the user's mobile unit 11.

In block 223, after successful delivery of the MT SMS message, the user interacts with the mobile unit 11 (typically via a series of key presses) to generate a reply MO SMS message addressed from the User's ANI and addressed to short code of the system (e.g., 29999). This reply message confirms acceptance of the premium SMS charge. This reply SMS message is communicated from the user's mobile unit 11 to the SMS-C 23, which forwards it on to the SMS gateway 25 as dictated by short code of the “To” address.

In block 224, the SMS Gateway 25 receives the reply MO SMS message and forwards the ANI of the user to the Manager Application Logic 33.

In block 225, the Manager Application Logic 33 cooperates with the SMS Gateway 25 to generate a MT premium-SMS message addressed from the system's short code (e.g., 29999) and addressed to the ANI of the user.

In block 226, the SMS Gateway 25 forwards the MT P-SMS message generated in block 225 to the SMS-C 23 for delivery to the user's mobile unit 11. In the MT Billing scheme employed herein, the user is billed the premium-SMS charge (e.g., $5.99) by the carrier payment processing system 37 upon successful delivery of the MT premium-SMS message to the user's mobile unit 11. In MO Billing schemes, the reply of block 223 would be encoded as a MO premium-SMS message (which triggers billing of the premium-SMS charge by the wireless carrier payment processing system 37 when the reply is sent from the user's mobile unit 11) and the operations of block 224 continue to block 227 with the operations of block 225 and 226 omitted.

In block 227, the Manager Application logic 33 passes the ANI of the user to the Billing Manager Logic 35, which cooperates with the carrier payment processing system 37 (typically via communication over a wide area network such as the Internet) in order to confirm that the premium charge was billed to the user's wireless carrier account. If this test passes, the Billing Manager Logic 35 updates the credits for the particular user and the operations continue to block 229 as described below; otherwise, the operations branch to block 228. Alternatively, as part of the payment processing of block 227, if the User (ANI) is an existing user, the Billing Manager Logic 39 may store payment information pertaining to the user (ANI), such as payment type (e.g., VISA, Mastercard, American Express, Discover, Debit Card, Checking Account), Account Number, Expiration date for Credit Cards, and possibly a 3 digit card verification code for Credit Cards. Such existing users may be asked if they wish to be charged on a particular credit card/debit card/checking account and for how much session time, e.g., 10 minutes for $4.99, 20 minutes for $9.49, or 30 minutes for $13.99. The Billing Manager Logic 35 then cooperates with a Credit Card Payment Processor 39 in order to charge the selected charge to the user's credit card/debit card/checking account. If these charge operations are successful, the Billing Manager Logic 35 updates the credits for the particular user and the operations continue to block 229. If these charge operations fail, the user may be notified of the billing failure by an MT SMS message are described below as part of block 228.

In block 228, the Manager Application Logic 33 cooperates with the SMS Gateway 25 to generate an MT SMS message addressed from the system's short code (e.g., 29999) and addressed to the ANI of the user. This SMS message provides an indication of the billing failure. The SMS gateway 25 forwards this SMS message to the SMS-C 23 for delivery to the user's mobile unit 11 and the processing ends. Alternatively, the SMS message may provide instructions for the user describing how to use additional payment options (e.g., credit card, debit card, checking account, etc.) by replying to the SMS message. This reply SMS message is received at the SMS Gateway 25 and passed on to the Manager Application Logic 33. In response thereto, the Manager Application Logic 33 cooperates with the Conference Bridge 31 to automatically dial the ANI of the User and employ voice scripts to gather payment information pertaining to the user (ANI), such as payment type (e.g., VISA, Mastercard, American Express, Discover, Debit Card, Checking Account), Account Number, Expiration date for Credit Cards, and possibly a 3 digit card verification code for Credit Cards. Such payment information is stored by the system for payment processing in conjunction with this particular user access request and subsequent access requests made by the particular user (block 227). The voice scripts confirm that the user wishes to be charged on a particular credit card/debit card/checking account and for how much session time (e.g., 10 minutes for $4.99, 20 minutes for $9.49, or 30 minutes for $13.99), and the operations return to block 227 for payment verification. In this scenario, the user may be placed on hold during the payment verification and then joined to the chat room service (blocks 229-233) without additional user call back operations.

In block 229, the Manager Application Logic 33 passes a message to the Conference Bridge 31 to join the user (ANI) to a chat room. For return users that have sufficient credits, the Manager Application Logic 33 may cooperate with the SMS Gateway 25 to generate an SMS message to the ANI of the user that provides an indication of the number of minutes remaining in their account and forward this SMS message to the SMS-C 23 for delivery to the user.

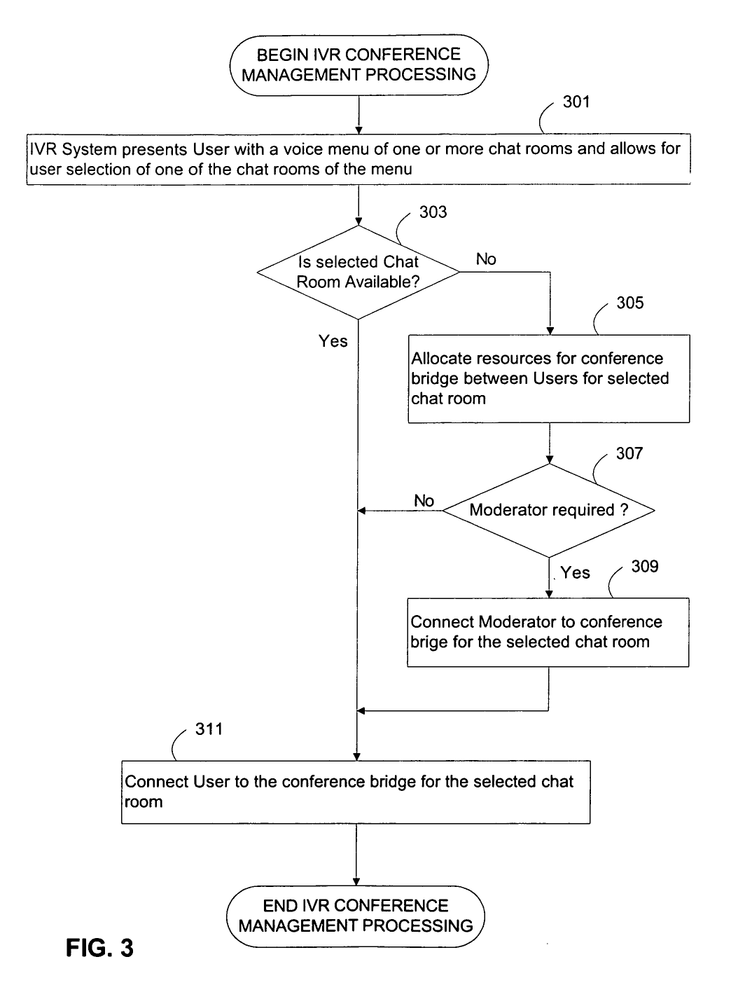

In block 231, the Conference Bridge 31 places one or more calls to the ANI of the user as dictated by the join message (block 229). In block 233, the Conference Bridge 31 updates the call connection status while connecting and while connected to the user's mobile unit 11 (block 233). Preferably, the Conference Bridge 31 makes three attempts to connect to the ANI of the user in block 231. After all three attempts fail, the Conference Bridge 31 updates the call connection status to “User Connection Failed.” If any one of the three attempts is successful, the Conference Bridge 31 updates the call connection status to “User Connection Successful” and invokes the IVR conference management processing of FIG. 3 as described below. In the event that the connection to the user is terminated for any reason (e.g., line noise, bad cell reception, user hanging up), the Conference Bridge 31 updates the call connection status to “User Connection Terminated.”

In block 235, the Manager Application Logic 33 checks whether the call connection status provided by the Conference Bridge 31 indicates that connection to the ANI of the mobile user has been successful (“User Connection Successful”). If the test of block 235 is successful, the operations continue to block 237 to start a User Session Timer which tracks the elapsed time of the user's call and the operations continue to block 241. If the test of block 235 fails, the operations continue to block 239.

In block 239, the Manager Application Logic 33 checks whether the call connection status provided by the Conference Bridge 31 indicates that connection to the ANI of the mobile user has failed (“User Connection Failed”). If the test of block 239 is successful, the operations continue to block 240 wherein the Manager Application Logic 33 cooperates with the SMS Gateway 25 to generate an MT SMS message addressed from the system's short code (e.g., 29999) and addressed to the ANI of the user. This SMS message provides an indication of the connection failure. This SMS message can also provide instructions for user to access the chat room service at a later time. The SMS gateway 25 forwards this SMS message to the SMS-C 23 for delivery to the user's mobile unit 11 and the processing ends. If the test of block 239 fails (i.e., the user connection has not failed), the operations loop back to block 235 to repeat testing for connection success (block 235) until either the connection is successful or the connection fails.

In block 241, the Manager Application Logic 33 checks whether the call connection status provided by the Conference Bridge 31 indicates that connection to the ANI of the mobile user has been terminated (“User Connection Terminated”). If the test of block 241 is successful, the operations continue to block 242 wherein the Billing Manager Logic 35 deducts the system-maintained credits based on elapsed session time and the operations end. The Manager Application Logic 33 may also cooperate with the SMS Gateway 25 to generate and forward an SMS message indicating that there is still session time available (e.g., “You have 4 minutes of call time left for use within the next 90 days.”) and describe how to return to a chat room in the future. If the test of block 241 fails, the operations continue to block 243.

In block 243, the Manager Application Logic 33 checks whether the session timer for the user has expired (e.g., exceeded 10 minutes). If the test of block 243 fails, the operations return to block 241 to repeat testing for connection termination (block 241) until the connection terminates or the session timer expires. If the test of block 243 is successful, the operations continue to blocks 245 and 247. In block 245, the Billing Manager Logic 35 deducts credits for the user based upon the expired session timer. In block 247, the Billing Manager Logic 35 checks whether the user has sufficient credits for rejoin the chat room (e.g., has sufficient credits for 10 more minutes of chatting). If the test of block 247 is successful, the operations continue to block 263 as described below. If the test of block 247 fails, the operations continue to block 249.

In block 249, the Manager Application Logic 33 passes a message to the Conference Bridge 31 to drop the user from the chat room. Upon receipt of the message, the Conference Bridge 31 drops the user (ANI) from the chat room and initiates a re-charge dialogue such as the following prompt “Your chat time has expired, you can buy an additional 10 minutes for $5.99 by pressing *1 . . . To decline such charge press *7 or hang up . . . ” If the user declines the re-charge in block 251, the operations continue to block 271 as described below. If the user accepts the re-charge in block 251, the operations continue to block 253.

In block 253, the Manager Application logic 33 cooperates with the SMS Gateway 25 to generate a MT SMS message addressed from the system's short code (e.g., 29999) and addressed to the ANI of the user. A simplified form of an exemplary MT SMS message generated in block 253 as rendered on the display of the user's mobile unit 11 is shown below:
From: 29999
To: (ANI)
By replying “Yes” or “Y” to this message, you confirm that you want to buy an additional 10 minutes of call time in a voice chat conference for a one-time charge of $5.99 on your mobile phone account.

In block 255, the SMS Gateway 25 forwards the MT SMS-message generated in block 253 to the SMS-C 23 for delivery to the user's mobile unit 11.

In block 257, after successful delivery of the MT premium-SMS message, the user interacts with the mobile unit 11 (typically via a series of key presses) to generate a reply MO SMS message addressed from the User's ANI and addressed to short code of the system (e.g., 29999). This reply message confirms acceptance of the premium SMS charge. This reply SMS message is communicated from the user's mobile unit 11 to the SMS-C 23, which forwards it on to the SMS gateway 25 as dictated by short code of the “To” address.

In block 258, the SMS Gateway 223 receives the reply MO SMS message and forwards the ANI of the user to the Manager Application Logic 33.

In block 259, the Manager Application Logic 33 cooperates with the SMS Gateway 25 to generate a MT premium-SMS message addressed from the system's short code (e.g., 29999) and addressed to the ANI of the user.

In block 260, the SMS Gateway 25 forwards the MT P-SMS message generated in block 259 to the SMS-C 23 for delivery to the user's mobile unit 11. In the MT Billing scheme employed herein, the user is billed the premium-SMS charge (e.g., $5.99) by the carrier payment processing system 37 upon successful delivery of the MT premium-SMS message to the user's mobile unit 11. In MO Billing schemes, the reply of block 257 would be encoded as a MO premium-SMS message (which triggers billing of the premium-SMS charge by the wireless carrier payment processing system 37 when the reply is sent from the user's mobile unit 11) and the operations of block 258 continues to block 261 with the operations of block 259 and 260 omitted.

In block 261, the Manager Application logic 33 passes the ANI of the user to the Billing Manager Logic 35, which cooperates with the carrier payment processing system 37 (typically via communication over a wide area network such as the Internet) in order to confirm that the premium charge was billed to the user's wireless carrier account. If this test passes, the Billing Manager Logic 35 updates the credits for the particular user and the operations continue to block 263; otherwise, the operations branch to block 267. Alternatively, as part of the payment processing operations of block 261, the user may asked if they wish to be charged on a particular credit card/debit card/checking account stored by the system and for how much session time, e.g., 10 minutes for $4.99, 20 minutes for $9.49, or 30 minutes for $13.99. The Billing Manager Logic 35 then cooperates with a Credit Card Payment Processor 39 in order to charge the selected charge to the user's credit card/debit card/checking account. If these charge operations are successful, the Billing Manager Logic 35 updates the credits for the particular user and the operations continue to block 263. If these charge operations fail, the user may be notified of the billing failure by an MT SMS message are described below as part of block 267.

In block 263, the Manager Application Logic 33 passes a message to the Conference Bridge 31 to rejoin the User (ANI) to the chat room. In block 265, upon receipt of the message, the Conference Bridge 31 rejoins the User (ANI) to the chat room and the operations return to block 233 as described above. The rejoin operations of block 365 may involve callback to the User (ANI) in the event that the User is disconnected from the Conference Bridge 31.

In block 269, the Manager Application Logic 33 passes a message to the Conference Bridge 31 to terminate the call to the User (ANI) and the operations continue to block 271. In block 271, the Conference Bridge terminates the call to the User (ANI) in the event that the user is still connected, frees all resources that were allocated to the User's call, and the processing ends for the call.

In block 267, wherein the Manager Application Logic 33 cooperates with the SMS Gateway 25 to generate an MT SMS message addressed from the system's short code (e.g., 29999) and addressed to the ANI of the user. This SMS message provides an indication of the billing failure. The SMS gateway 25 forwards this SMS message to the SMS-C 23 for delivery to the user's mobile unit 11 and the operations continue to block 269.

Turning now to FIG. 3, there is shown a flow chart depicting operations of the Conference Bridge 31 in managing multiparty chat room sessions as part of the application of FIG. 1. There are a limited number of users (e.g., 6) that can be conferenced together as part of a given chat room session. Users are typically all anonymous; however, the identity of a user can be made known at the user's own choice. Each chat room session is preferably moderated by a designated participant (in addition to the possible 6 users to the conference), although the other users may or may not be aware that one participant is a moderator. The moderator's telephony device 36 is coupled to the Conference Bridge 31 as shown in FIG. 1. Preferably, the main role of the moderator is to stimulate interesting conversation and control “inappropriate” users (i.e., users using abusive or offensive language). The moderator may also be provided with control logic such as an agent GUI (not shown) that is coupled to the Conference Bridge 31 to allow for supplementary services, such as the moderator pairing off select users of the chat room session into private (non-moderated) chat room sessions, the moderator joining the user to another chat room session or the moderator passing the user to a voice menu for additional services. Additional charges, such premium-SMS charges or additional credit card charges, can be billed to the users for such supplementary services. The Conference Bridge 31 can be programmed to employ voice scripts that disclose the additional charges for such services and confirm user acceptance of such charges prior to invoking such services. Furthermore, the Billing Manager Logic 35 can be programmed to automatically verify payment of such additional charges prior to invoking such services.

In block 301, the IVR system presents the user with a voice introduction and menu of one or more chat rooms and allows for user selection therefrom. An example of such a voice introduction and menu follows:
“Hi. This is your mobile Text-to-Chat service. You have XX (e.g., 10) minutes of call time available for joining up to seven other anonymous users in any of the following chat rooms . . .
For Hot Movies, Press 1#
For Hot Music, Press 2#
For Personal Confessions, Press 3#
For Relationships, Press 4#
For Astrology, Press 5#
You can hang up at any time and, for 60 days, keep your remaining minutes for spending in a different chat room. To re-connect just text “Call” to 29999 once more. Please make your selection now . . . To repeat the chat room choices, Press ##”

Upon user selection of a particular chat room, the operations continue to block 303 to check whether the user selected chat room is available. If so, the operations continue to block 311. If not, the operations continue to blocks 305 and 307.

In block 305, the resources for a new chat room session are allocated. In block 307, it is determined whether a moderator is required. If not, the operations continue to block 311. If so, the operations continue to blocks 309 wherein a moderator is connected to the Conference Bridge 31 for the chat room session and then the operations continue to block 311.

In block 311, the user is connected to the Conference Bridge 31 for the chat room session and the processing ends.

Note that the resources allocated for each respective chat room session preferably remain allocated until no users remain connected thereto. At this time, the moderator may be disconnected from the Conference Bridge 31 for the given chat room session and possibly assigned to another chat room session as needed. Also note that the Conference Bridge 31 may be programmed to listen for a predetermined DTMF tone issued by the user, which causes the Conference Bridge 31 to remove the user from the selected chat room session and present the user with the initial voice introduction and menu (block 301) such that the user can move between different chat room sessions as desired.

It is also contemplated that a user can request access to a particular chat room, for example by clicking on a web page link associated with a particular chat room (block 211), or by including text that specifies the particular chat room as part of the reply SMS message that is communicated to the system (block 223). In these instances, the IVR Conference Management Processing need not present the user with the menu of chat rooms (block 301) but can proceed directly block 303 in order to connect the user to the particular chat room (block 311).

There may be other mechanisms for users to request access to the chat room(s) maintained by the system of FIG. 1, including for example, the user operating a browser or other application on a computing device and accessing a web site, a phone client application wherein the user calls the IVR Multiparty Conference Bridge 31 (or another IVR system) via a mobile phone, traditional land line phone, VO-IP phone or other telephony device and interacts with predetermined voice scripts to generate such requests, the user sending a non-premium SMS message to the short code of the chat room service, the user sending other message types (such as IM messages) to a designated email address of the chat room service, the user executing a client application (e.g., a Java client application) on the mobile unit 11. In most cases, such user interaction will be replied to with an SMS text message asking for confirmation, by replying “Yes” or “Y” to the message that the user wants to buy a predetermined number (e.g., 10 minutes) of chat time for a one-time premium-SMS charge ($5.99) on his/her mobile phone account. MT Premium-SMS billing (or possibly MO SMS-billing is used to bill the premium-SMS charge onto the user's mobile phone account. Such billing is confirmed before joining the user to the Conference Bridge 31.

As described above, users are preferably connected to the IVR Multiparty Conference Bridge 31 by callback operations wherein a call is placed from the Bridge 31 to the user's telephony device. Such call back operations can place a call to a wide variety of user telephony devices, such as mobile units as described above, a traditional land-line phone over the PSTN, a VOIP phone over the Internet, an IM application over the Internet, etc. In such embodiments, the IVR Multiparty Conference Bridge 31 is adapted to interface to the users telephony devices over such communication networks (e.g., one or more wireless cellular networks, the PSTN, Internet) in order to place calls to users of the system.

In alternate embodiments, one or more users can connect to the IVR Multiparty Conference Bridge 31 by placing a call from the user's telephony device to the Bridge 31. A wide variety of user telephony devices can be used, including mobile units as described above, a traditional land-line phone over the PSTN, a VOIP phone over the Internet, an IM application over the Internet, etc. In such embodiments, the IVR Multiparty Conference Bridge 31 is adapted to interface to the users telephony devices over such communication networks (e.g., one or more wireless cellular networks, the PSTN, Internet) in order to receive calls from users of the system.

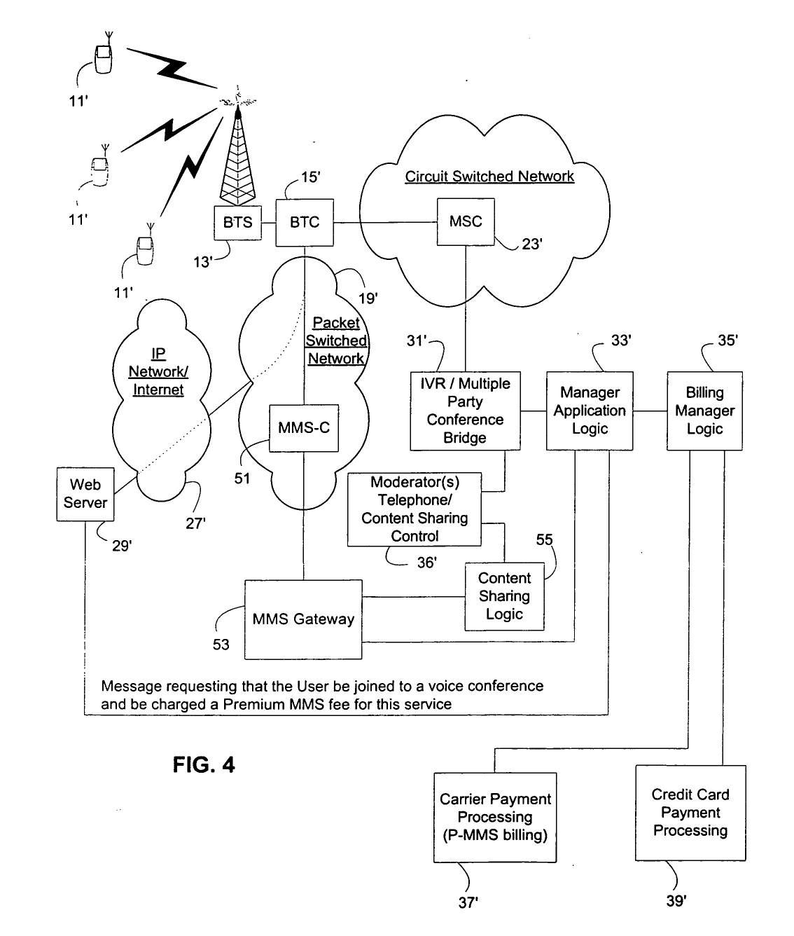

FIG. 4 depicts an alternate architecture for carrying out the voice chat sessions with multiple users over advanced wireless cellular networks with like numerals designating the processing functionality described above for the system of FIG. 1. Such advanced wireless cellular networks support the communication of Multimedia Messaging System (MMS) messages to and from compatible mobile units 11′. MMS messages are not limited to only text, but can include various kinds of multimedia content (e.g. images, audio and/or video clips). Mobile users send MT MMS messages using an MMS client on the mobile unit 11′ to compose, address, and send an MMS message to one or more recipients. MMS addresses can be either standard phone numbers (e.g., “+18005551212”) or standard e-mail addresses (e.g., “you@yourdomain.com”). The MMS message is communicated from the mobile unit 11′ to an MMS Center (MMS-C) 51 as packet switched traffic over the packet switched network 19′. Mobile users also receive MT MMS messages via communication from the MMS-C 51 as packet switched traffic over the packet switched network 19′. Similar to the SMS-C 23 of FIG. 1, the MMS-C 51 functions as a centralized store-and-forward device that accepts MMS messages and buffers the received MMS messages until a suitable delivery time (i.e., the cell phone is powered on and the location known). The MMS-C 51 also provides an interface in accordance with a communication protocol (e.g., UCP, SMPP, Sema OIS, CIMD2) that allows for routing of MMS messages to and from other cell networks and to and from other external MMS processing devices (e.g., the MMS gateway 53). Preferably, the external SMS processing devices are connected to the MMS-C 51 over a wide area network such as the Internet.

In the embodiment of FIG. 4, mobile users pay for access to the public voice chat room by a premium-MMS payment scheme. In this payment scheme, the mobile user is charged a premium fee that is billed to his/her mobile carrier account when a premium-MMS message type is received or sent from the user's mobile unit 11. Mobile-Terminated (MT) Billing refers to the scheme where the Premium-MMS message is billed when it is received on the user's mobile unit 11. Mobile-Originated (MO) billing refers to the scheme where the premium-MMS message is billed when it is sent from the user's mobile unit 11. The embodiment described herein employs MT Billing. However, it can readily be adapted to use MO Billing as needed.

In order to support the premium-MMS payment scheme, the system includes an MMS gateway 53 that interfaces to the MMS-C 51, Billing Manager Logic 35′ that interfaces to the carrier billing processing system 37′, and Manager Application Logic 33′ that interfaces to the MMS gateway 33′, the Billing Manager Logic 35′ and the Conference Bridge 31′ as shown. The Billing Manager Logic 35′ may also interface to a credit card payment processor 39′ as shown in order to support credit card payments and possibly debit card payments for user access to the voice chat service described herein.

The MMS gateway 53 generates outgoing MT MMS messages from a predetermined short code (e.g., 2999) to one or more of the mobile units 11′ and forwards the MT MMS messages to the MMS-C 51 for forwarding to the destination mobile unit(s). The MMS gateway 53 also receives incoming MO MMS messages from the mobile units 11′ to the predetermined short code (e.g., 2999). The MMS gateway 53 interfaces to the MMS-C 51 utilizing a communication protocol such as UCP, SMPP, Sema OIS, CIMD2 that allows for the routing of SMS messages therebetween. Preferably, the MMS Gateway 53 is connected to the MMS-C 53 over a wide area network such as the Internet.

The Manager Application Logic 33′ coordinates with the MMS gateway 53 to request and acknowledge payment for user access to the voice chat room service by premium-MMS payment in a manner similar to the premium-SMS payment scheme described above with respect to FIGS. 2A-2D. In this embodiment, MMS messages are substituted for the SMS messages as described therein. Note however that a dual MMS-SMS system can also be employed wherein both MMS and SMS messages are communicated to and from the user's mobile unit 11′ as part of the voice chat service.

The Manager Application Logic 33′ also coordinates with the Billing Manager Logic 35′ to confirm that the premium-MMS payment was billed by the carrier. Alternatively, the Manager Application Logic 33 may coordinate with the Billing Manager Logic 35′ to charge the premium access fee (and/or other service related fees) to a credit card account or possible a debit card account provided by the mobile user.

In this exemplary embodiment, the moderator may be provided with a telephone-enabled PC 36′ or other suitable device. The telephone-enabled PC 36′ is coupled to the Conference Bridge 31 to allow the moderator to participate in voice chat sessions managed by the Conference Bridge 31. The telephone-enabled PC 36′ also preferably employs an agent GUI that allows for supplementary services, such as the moderator pairing off select users of the chat room session into a private (non-moderated) chat room session, the moderator joining the user to another chat room session or the moderator passing the user to a voice menu for additional services. As part of such supplementary services, the agent GUI can also cooperate with content sharing logic 55 such that the moderator can enable users of a given chat room session to share multimedia content (test messages, audio files, video files) an/or possibly allow the moderator to push multimedia content to one or more users of the given chat room session. Additional charges, such premium-MMS charges or additional credit card charges, can be billed to the users for such supplementary services. The Conference Bridge 31′ can be programmed to employ voice scripts that disclose the additional charges for such services and confirm user acceptance of such charges prior to invoking such services. Furthermore, the Billing Manager Logic 35′ can be programmed to automatically verify payment of such additional charges prior to invoking such services.

The delivery of multimedia content to the users of the system can be accomplished via the content sharing logic 55 as part of a store and forward architecture. Alternatively, the delivery of such multimedia content can be accomplished by communication between the user's multimedia devices without forwarding such content to the content sharing logic 55. Preferably, the content sharing logic 55 communicates with the intended receiving user's multimedia device firstly determine the make and model of the device so as to correctly determine the correct content format for such device and then to trigger the display of a display screen thereon that allows the intended receiving user to accept, decline, postpone or forward delivery of such multimedia content. If the intended receiving user accepts delivery of the multimedia content, the correctly formatted multimedia content is delivered immediately to the receiving user's multimedia device. If the intended receiving user postpones delivery of the content, the content sharing logic 55 waits for a predetermined time period (e.g., 5 minutes) before it communicates again with the intended receiving user's multimedia device to trigger the display of the display screen thereon that allows the intended receiving user to accept, decline, postpone or forward delivery of such content. If the intended receiving user forwards delivery of the content, the intended receiving user identifies the multimedia device to which the content is to be forwarded via the device's Mobile Identification Number or other identifiable address e.g. email address, and the content sharing logic 55 communicates with the forwarded device to firstly determine the make and model of the device so as to correctly determine the correct content format for such device and then to trigger the display of the display screen thereon that allows the intended receiving user to accept, decline, postpone or forward delivery of such content. If the intended receiving user declines delivery of the content, the data communication that delivers the multimedia content to the intended receiving user will not occur. Upon declining delivery, the intended receiving user may be presented with a secondary display screen that provides one or more options to the users. Such options preferably include Quit, Snooze, Forward (as described above), Block actions. The Snooze action will decline an immediate data connection that delivers the multimedia content to the intended receiving user, but will instruct the content sharing logic 55 to initiate this data connection after waiting a predetermined time period (e.g., 5 minutes). The Block action will modify the profile of the intended receiving user in order to disallow content sharing between the sending user and the intended receiving user.

There may be other mechanisms for users to request access to the chat room(s) maintained by the system of FIG. 4, including for example, the user operating a browser or other application on a computing device and accessing a web site, a phone client application wherein the user calls the IVR Multiparty Conference Bridge 31′ (or another IVR system) via a mobile phone, traditional land line phone, VO-IP phone or other telephony device and interacts with predetermined voice scripts to generate such requests, the user sending a non-premium MMS message to the short code of the chat room service, the user sending other message types (such as IM messages) to a designated email address of the chat room service, the user executing a client application (e.g., a Java client application) on the mobile unit. In most cases, such user interaction will be replied to with an MMS message asking for confirmation, by replying “Yes” or “Y” to the message that the user wants to buy a predetermined amount of chat time for a one-time premium-MMS charge on his/her mobile phone account. MT Premium-MMS billing (or possibly MO MMS-billing is used to bill the premium-SMS charge onto the user's mobile phone account. Such billing is confirmed before joining the user to the Conference Bridge 31′.

Users are preferably connected to the IVR Multiparty Conference Bridge 31′ by callback operations wherein a call is placed from the Bridge 31′ to the user's telephony device. Such call back operations can place a call to a wide variety of user multimedia-telephony devices, such as mobile units as described above, VOIP phones over the Internet, IM or other applications over the Internet, etc. In such embodiments, the IVR Multiparty Conference Bridge 31′ and the content sharing logic 55 are adapted to interface to the users multi-media telephony devices over such communication networks (e.g., one or more wireless cellular networks, Internet) in order to place calls to users of the system and share multimedia content therebetween. Note that such communications can employ mechanisms other than MMS messaging for distributing multimedia content (for example, conventional HTTP processing).

In alternate embodiments, one or more users can connect to the IVR Multiparty Conference Bridge 31′ by placing a call from the user's multimedia-telephony device to the Bridge 31′. A wide variety of user multimedia-telephony devices an be used, including mobile units as described above, VOIP phones over the Internet, IM or other applications over the Internet, etc. In such embodiments, the IVR Multiparty Conference Bridge 31′ and the content sharing logic 55 are adapted to interface to the user's multimedia-telephony devices over such communication networks (e.g., one or more wireless cellular networks, Internet) in order to receive calls from users of the system and share multimedia content therebetween. Note that such communications can employ mechanisms other than MMS messaging for distributing multimedia content (for example, conventional HTTP processing or other suitable protocols).

There have been described and illustrated herein several embodiments of a moderated voice chat system and methods of operating such systems. While particular embodiments of the invention have been described, it is not intended that the invention be limited thereto, as it is intended that the invention be as broad in scope as the art will allow and that the specification be read likewise. Thus, it will be appreciated that the conference bridging functionality can readily be adapted to interface to different types of telephony devices for carrying out the moderated chat room service, including land line telephones via the public switched telephone network and VOIP telephony devices via the Internet. Such VOIP telephony devices can employ Internet Messaging (IM) technology (voice over IM service) or Peer-to-Peer technology (e.g., Skype Voice Service). Other technologies could be used as well. It will therefore be appreciated by those skilled in the art that yet other modifications could be made to the provided invention without deviating from its spirit and scope as claimed.

What is claimed is:

1. A method for voice conferencing between multiple users comprising:
managing a plurality of moderated voice chat room sessions, wherein a moderator is joined as a participant of each respective moderated voice chat room session;
receiving a plurality of access requests associated with users, each access request including an identifier corresponding to a given user's telephony device; and
for each particular access request,
using the identifier of the particular access request to place a call to the corresponding user's telephony device in order to connect to the corresponding user's telephony device;
subsequent to connection to the corresponding user's telephony device, supplying a voice menu to the user via the user's telephony device, wherein the voice menu identifies the plurality of moderated voice chat sessions; and
joining the corresponding user's telephony device to a selected one of the plurality of moderated voice chat room sessions as selected by user input in accordance with the voice menu, wherein the user is joined as an anonymous participant to the selected one moderated voice chat room session.

2. A method according to claim 1, wherein:
the access request for at least one user is initiated in response to user interaction with a web server.

3. A method according to claim 1, wherein:
the access request for a particular user comprises a message that is addressed to a predetermined system identifier.

4. A method according to claim 3, wherein:
the message comprises one of an SMS message, an MMS message and an IM message.

5. A method according to claim 3, wherein:
the message is addressed from the identifier of the particular user's telephony device.

6. A method according to claim 1, wherein:
before joining the user's telephony device to the selected moderated voice chat room session, communicating a premium rate message to the user and verifying that the premium rate message was successfully billed to the user.

7. A method according to claim 6, further comprising:
tracking credits for each user, wherein credits are deducted for time that a user is joined to a moderated voice chat room session, and
adding credits for the user as a result of billing the user for the premium rate message.

8. A method according to claim 6, wherein:
the premium rate message comprises one of a mobile-terminated premium-SMS message communicated to the user's mobile unit and a mobile-originated premium-SMS message communicated from the user's mobile unit.

9. A method according to claim 8, wherein:
the user's mobile unit is the user's telephony device that is joined to the selected moderated voice chat room session.

10. A method according to claim 6, wherein:
the premium rate message comprises one of a mobile-terminated premium-MMS message communicated to the user's mobile unit and a mobile-originated premium-MMS message communicated from the user's mobile unit.

11. A method according to claim 10, wherein:
the user's mobile unit is the user's telephony device that is joined to the selected moderated voice chat room session.

12. A method according to claim 6, wherein:
in the event of failure of verification that the premium rate message was successfully billed to the user, interacting with the user via voice scripts to collect additional payment information and using such additional payment information to bill the user.

13. A method according to claim 12, wherein:
the additional payment information includes at least one of credit card information, debit cart information, and checking account information.

14. A method according to claim 12, wherein:
tracking credits for each user, wherein credits are deducted for time that a user is joined to a moderated voice chat room session, and
adding credits for a user as a result of billing the user employing the additional payment information.

15. A method according to claim 1, further comprising:
enabling the moderator to provide supplementary services.

16. A method according to claim 15, wherein:
the supplementary services include pairing-off select participants of a moderated voice chat room session into a private room session.

17. A method according to claim 15, wherein:
the supplementary services include joining one or more select participants of a moderated voice chat room session to another chat room session.

18. A method according to claim 15, wherein:
the supplementary services include passing one or more select participants of a moderated voice chat room session to a voice menu for additional services.

19. A method according to claim 15, wherein:
the supplementary services include sharing multimedia content between participants of a moderated voice chat room session.

20. A method according to claim 15, wherein:
the supplementary services include pushing multimedia content to one or more participants of a moderated voice chat room session.

21. A method according to claim 15, further comprising:
billing additional charges to a user for the supplementary services.

22. A method for voice conferencing between multiple users comprising:
managing a voice chat room session wherein each user is joined as an anonymous participant of the voice chat room session; and
before joining a user's telephony device to the voice chat room session, communicating a premium rate message to the user and verifying that the premium rate message was successfully billed to the user.

23. A method according to claim 22, further comprising:
tracking credits for each user, wherein credits are deducted for time that a user is joined to the voice chat room session, and
adding credits for the user as a result of billing the user for the premium rate message.

24. A method according to claim 22, wherein:
the premium rate message comprises one of a mobile-terminated premium-SMS message communicated to the user's mobile unit and a mobile-originated premium-SMS message communicated from the user's mobile unit.

25. A method according to claim 24, wherein:
the user's mobile unit is the user's telephony device that is joined to the voice chat room session.

26. A method according to claim 22, wherein:
the premium rate message comprises one of a mobile-terminated premium-MMS message communicated to the user's mobile unit and a mobile-originated premium-MMS message communicated from the user's mobile unit.

27. A method according to claim 26, wherein:
the user's mobile unit is the user's telephony device that is joined to the voice chat room session.

28. A method according to claim 22, wherein:
a moderator is joined as a participant of the voice chat room session.

29. A method according to claim 22, wherein:
at least one user is called by a call back operation before being joined to the voice chat room session.

30. A method according to claim 22, wherein:
the user selects the voice chat room session from a voice menu of voice chat room sessions.

31. A method for voice conferencing between multiple users comprising:
managing a plurality of voice chat room sessions, wherein multiple users are conferenced together in each voice chat room session; and
selectively enabling communication of multimedia information between users that are conferenced together in a given voice chat room session.

32. A method according to claim 31, further comprising:
joining a moderator as a participant of the given chat room session.

33. A method according to claim 32, further comprising:
presenting the moderator with a graphical user interface that allows the moderator to enable communication of multimedia information between users that are conferenced together in the given voice chat room session.

34. A method according to claim 32, wherein:
presenting the moderator with a graphical user interface that allows the moderator to communication multimedia information to at least one user that is joined to the given voice chat room session.
